(19) United States
(12) Patent Application Publication
(10) Pub. No.: US 2013/0218876 A1
(43) Pub. Date: Aug. 22, 2013

(54) METHOD AND APPARATUS FOR ENHANCING CONTEXT INTELLIGENCE IN RANDOM INDEX BASED SYSTEM

(71) Applicants: Mikko Aleksi Lönnfors, Katu (FI); Eki Petteri Monni, Espoo (FI); Istvan Beszteri, Espoo (FI); Minna Kirsi Marja Hellstrom, Tuusula (FI); Mikko J. Terho, Tampere (FI)

(72) Inventors: Mikko Aleksi Lönnfors, Katu (FI); Eki Petteri Monni, Espoo (FI); Istvan Beszteri, Espoo (FI); Minna Kirsi Marja Hellstrom, Tuusula (FI); Mikko J. Terho, Tampere (FI)

(73) Assignee: NOKIA CORPORATION, Espoo (FI)

(21) Appl. No.: 13/402,717

(22) Filed: Feb. 22, 2012

(51) Int. Cl. G06F 17/30

(52) U.S. Cl. 707/723; 707/E17.014

(57) ABSTRACT

A method for providing enhancement of context intelligence may include receiving a first word representing a context at a processor, providing for a search of a database using the first word; receiving a second word in response to the search of the database, applying a weight to the second word, and causing the second word and the respective weight to be stored as relevant to the context. The database may include a remote database, accessed, for example, via the internet. The method may also include generating a third word in response to a sensor receiving an input, where providing for a search of a database includes using the first word and the third word. The method may optionally include generating a third word in response to a detected property of an environment, where providing for a search of a database includes using the first word and the third word.

### TECHNOLOGICAL FIELD

Embodiments of the present invention relates generally to user interface technology and, more particularly, relate to a method and apparatus for expanding the context understood by a device to facilitate improvement of interaction flow with respect to user interface operations with the device.

### BACKGROUND

The modern communications era has brought about a tremendous expansion of wireline and wireless networks. Computer networks, television networks, and telephony networks are experiencing an unprecedented technological expansion, fueled by consumer demand. Networking technologies have addressed related consumer demands, while providing more flexibility and immediacy of information transfer.

Devices, such as computers and cellular telephones, have become smaller and lighter while also becoming more capable of performing a variety of tasks and applications. The increase in capabilities has resulted in greater interaction between the device and the user such that the user interface is an integral part of such devices. Devices are capable of receiving a great deal of input through a variety of mechanisms and interpreting the input to perform a variety of functions. Interpretation of an input can range from a simple direct correlation between an input and a function to be performed to a complex interpretation of an input using context and other factors to perform a function. Context may also help a device anticipate or predict the actions or behaviors of a user. Through the use of context, a device may be capable of performing tasks more quickly and anticipating likely user inputs thereby simplifying the user interface of the device.

### BRIEF SUMMARY

A method, apparatus and computer program product are therefore provided to enhance a context intelligence system for accurate and reliable context identification. In this regard, for example, some embodiments may provide a mechanism to use user-supplied information to broaden the definition of a context for improved accuracy and reliability.

In one example embodiment, a method of enhancing context intelligence in a random index based system is provided. The method may include receiving a first word representing a context at a processor, providing for a search of a database using the first word, receiving a second word in response to the search of the database, applying a weight to the second word, and causing the second word and the respective weight to be stored as relevant to the context. The database may include a remote database, accessed, for example, via the interne. The method may also include generating a third word in response to a sensor receiving an input, where providing for a search of a database includes using the first word and the third word. The method may optionally include generating a third word in response to a detected property of an environment, where providing for a search of a database includes using the first word and the third word. The weight of the second word may represent the relevance to the second word to the context. The method may optionally include requesting user input relative to the context and the first word may be received in response to the request for user input. Requesting user input relative to the context may be performed in response to a context confidence level being below a pre-defined threshold.

In another example embodiment, an apparatus enhancing context intelligence in a random index based system is provided. The apparatus may include at least one processor and at least one memory including computer program code. The at least one memory and the computer program code may be configured to, with the at least one processor, cause the apparatus to perform at least receive a first word representing a context, provide for a search of a database using the first word, receive a second word in response to the search of the database, apply a weight to the second word, and cause the second word and the respective weight to be stored as relevant to the context. The database may include a remote database. The apparatus may further be caused to generate a third word in response to a sensor receiving an input, where providing for a search of a database includes using the first word and the second word. The apparatus may optionally be caused to generate a third word in response to a detected property of an environment, where providing for a search of a database includes using the first word and the third word. The weight of the second word may represent the relevance of the second word to the context. The apparatus may further be caused to request user input relative to the context, where the first word is received in response to the request for user input. Requesting user input relative to the context may be performed in response to a context confidence level being below a pre-defined threshold.

In one example embodiment, another apparatus for enhancing context intelligence in a random index based system is provided. The apparatus may include means for receiving a first word representing a context, means for providing for a search of a database using the first word, means for receiving a second word in response to the search of the database, means for applying a weight to the second word, and means for causing the second word and the respective weight to be stored as relevant to the context. The database may include a remote database. The apparatus may further include means for generating a third word in response to a sensor receiving an input, where the means for providing for a search of a database includes using the first word and the third word. The apparatus may optionally include means for generating a third word in response to a detected property of an environment, where the means for providing for a search of a database includes using the first word and the third word. The weight of the second word may represent the relevance of the second word to the context. The apparatus may optionally include means for requesting user input relative to the context, where the first word is received in response to the request for user input. Requesting user input relative to the context may be performed in response to a context confidence level being below a pre-defined threshold.

In one example embodiment, a computer program product enhancing context intelligence in a random index based system is provided. The computer program product may include at least one computer-readable storage medium having computer-executable program code instructions stored therein. The computer-executable program code instructions may include program code instructions for receiving a first word representing a context, program code instructions for providing for a search of a database using the first word, program code instructions for receiving a second word in response to the search of the database, program code instructions for applying a weight to the second word, and program code instructions for causing the second word and the respective weight to be stored as relevant to the context. The database may include a remote database. The computer program product may optionally include program code instructions for generating a third word in response to a sensor receiving an input, where the program code instructions for providing for a search of a database includes using the first word and the third word. The computer program product may optionally include program code instructions for generating a third word in response to a detected property of an environment where the program code instructions for providing for a search of a database includes using the first word and the third word. The weight of the second word may represent the relevance of the second word to the context. The computer program product may optionally include program code instructions for requesting user input relative to the context, where the first word may be received in response to the request for user input.

An example embodiment of the invention may provide a method, apparatus and computer program product for enhancing context intelligence in a random index based system. As a result, for example, mobile terminal and other computing device users may enjoy an improved user interaction based on the provision of improved context recognition processes.

### BRIEF DESCRIPTION OF THE DRAWING(S)

Having thus described some embodiments of the invention in general terms, reference will now be made to the accompanying drawings, which are not necessarily drawn to scale, and wherein:

FIG. 1 is a schematic block diagram of a wireless communications system according to an example embodiment of the present invention;

FIG. 2 illustrates a block diagram of an apparatus for supporting enhancement of context intelligence according to an example embodiment of the present invention;

FIG. 3 illustrates a graphical representation of search results related to a word search according to an example embodiment of the present invention;

FIG. 4 illustrates a flow diagram of a method for enhancing the contextual intelligence of a device according to an example embodiment of the present invention; and

FIG. 5 is a flowchart according to a method for enhancing the contextual intelligence of a device according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Enhancing or otherwise improving the user experience in relation to the interaction between the user and the user's electronic device is a constant goal of device designers and manufacturers. The ability to provide more seamless user interaction can be a highly determinative factor in creating marketing awareness to sell products and in creating customer loyalty and satisfaction. Providing a smooth flow of interaction with relatively little or at least a minimal amount of user input may be considered to provide the best user experience. In other words, users often prefer interaction that is automatic or appears as automatic as possible.

To provide users with a fluid and minimally invasive interaction experience, accurate and fast estimations of user intent or estimations of expected user actions may be important factors. Context information may be useful in enabling a device to make such estimations in a fast and reliable manner. Accordingly, many devices employ sensors and/or current device state or user activity monitors to determine context information that may be applicable and useable for improving user interaction. Context may be determined based on a number of factors including: detecting a property of the environment in which a device is located; receiving a signal from a sensor; receiving an input from a user; or otherwise receiving information at the device.

Some example embodiments of the present invention may provide a mechanism by which context accuracy and breadth is improved by adding context definitions and scope to a given context. Adding context definitions and broadening the scope of a context may be performed by searching an external, remote database for words relevant to a given context and adding words resulting from the search to a database used in context determination.

Several example embodiments of the present invention will be described herein with reference to contexts of a system as well as a framework of random indexing. It is to be noted, however, that the invention is not limited to these uses or alternatives. In fact, the different embodiments have applications in any environment where context realization may be used. As an example, a context processing system may be mapped to a lexical system of “words” and “documents.” The documents may contain a set of words that define a single realization of a context, e.g., at a certain time instance.

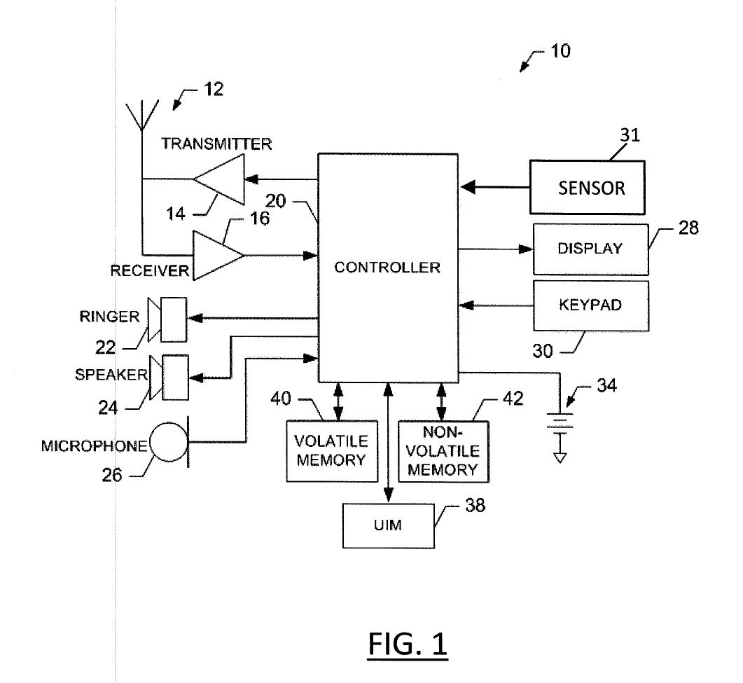

FIG. 1 illustrates one example embodiment of the invention including a block diagram of a mobile terminal 10 that may benefit from embodiments of the present invention. It should be understood, however, that a mobile terminal as illustrated and hereinafter described is merely illustrative of one type of device that may benefit from embodiments of the present invention and, therefore, should not be taken to limit the scope of embodiments of the present invention. While several embodiments of the mobile terminal 10 may be illustrated and hereinafter described for purposes of example, other types of mobile terminals, such as portable digital assistants (PDAs), pagers, mobile televisions, gaming devices, all types of computers (e.g., laptops or mobile computers), cameras, audio/video players, radio, global positioning system (GPS) devices, or any combination of the aforementioned, and other types of communications systems, may readily employ embodiments of the present invention. Even fixed devices may employ some example embodiments.

The mobile terminal 10 may include an antenna 12 (or multiple antennas) in operable communication with a transmitter 14 and a receiver 16. The mobile terminal 10 may further include an apparatus, such as a controller 20 or other processing hardware that controls the provision of signals to and the reception of signals from the transmitter 14 and receiver 16, respectively. The signals may include signaling information in accordance with the air interface standard of the applicable cellular system, and/or may also include data corresponding to user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-URSA (evolved-universal terrestrial radio access network), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

It is understood that the apparatus, such as the controller 20, may include circuitry implementing, among others, audio and logic functions of the mobile terminal 10. For example, the controller 20 may comprise a digital signal processor device, a microprocessor device, and various analog to digital converters, digital to analog converters, and/or other hardware support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as an earphone or speaker 24, a ringer 22, a microphone 26, a display 28, and a user input interface, which may be coupled to the controller 20. The user input interface, which allows the mobile terminal 10 to receive data, may include any of a number of devices allowing the mobile terminal 10 to receive data, such as a keypad 30, a touch display (not shown), a microphone 26 or other input device. In embodiments including the keypad 30, the keypad 30 may include numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are used to operate the mobile terminal 10, as well as optionally providing mechanical vibration as a detectable output.

The mobile terminal 10 may also include a sensor 31 that is capable of detecting properties of an environment of the mobile terminal. Such properties may include temperature, location, speed of movement, light levels, humidity, pressure, or any number of properties. The sensor 31 may also be capable of detecting inputs by a user through motion (e.g., an accelerometer), position (e.g., by magnetic field sensing), or any number of possible inputs. Thus, the sensor 31 may provide valuable information to the controller 20 with regard to context.

The mobile terminal 10 may further include a user identity module (UIM) 38, which may generically be referred to as a smart card. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), or any other smart card. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The non-volatile memory 42 may additionally or alternatively comprise an electrically erasable programmable read only memory (EEPROM), flash memory or the like. The memories may store any of a number of pieces of information, and data, used by the mobile terminal 10 to implement the functions of the mobile terminal 10.

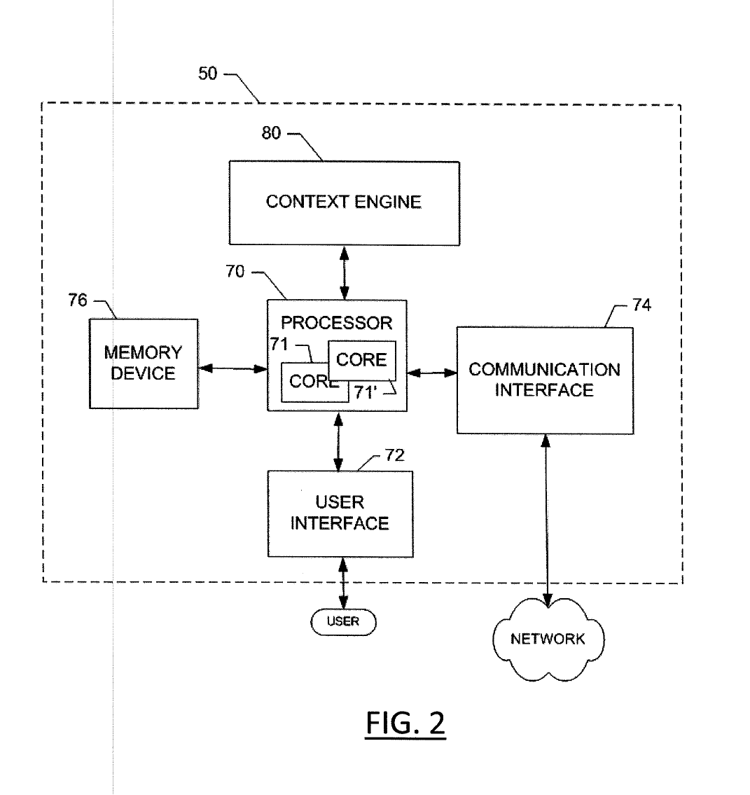

FIG. 2 illustrates a schematic block diagram of an apparatus for expanding the context understood by the apparatus and improving the accuracy and breadth of context according to an example embodiment of the present invention. An example embodiment of the invention will now be described with reference to FIG. 2, in which certain elements of an apparatus 50 for providing context classification are displayed. The apparatus 50 of FIG. 2 may be employed, for example, on the mobile terminal 10. However, the apparatus 50 may alternatively be embodied at a variety of other devices, both mobile and fixed. In some cases, an embodiment may be employed on either one or a combination of devices. Accordingly, some embodiments of the present invention may be embodied wholly at a single device (e.g., the mobile terminal 10), by a plurality of devices in a distributed fashion or by devices in a client/server relationship. Furthermore, it should be noted that the devices or elements described below may not be mandatory and thus some may be omitted in certain embodiments.

Referring now to FIG. 2, an apparatus for providing context classification is provided. The apparatus 50 may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a vector processor, a graphics processing unit (GPU), a special-purpose computer chip, or other similar hardware processors. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal, a fixed terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, or a combination of hardware and software, that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an exemplary embodiment, the processor 70 may be embodied as, include or otherwise control a context engine 80. As such, in some embodiments, the processor 70 may be said to cause, direct or control the execution or occurrence of the various functions attributed to the context engine 80 as described herein. The context engine 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the context engine 80 as described herein. Thus, in examples in which software is employed, a device or circuitry (e.g., the processor 70 in one example) executing the software forms the structure associated with such means. As such, the context engine 80 may be capable of performing the identification of a particular context through a random index technique given a word or words related to the context.

Example embodiments of the invention may expand the context that may be understood by a user device (such as apparatus 50) to improve the context intelligence of a device for predicting or estimating user behavior and action. Context may be stored in a system using a random index based implementation. Context may be described using words (e.g., English words), that are meaningful from a user point of view and can help to identify a given context and what is relevant to that particular context. A random index matrix may be able to represent the relationships between words and a particular context. For example, a given set of words may represent a given context. In an example embodiment, if a user is at home, a context may include: a) time: morning; b) location: London; c) movement: moving; and d) weather: rainy. These words may indicate to a device that it is in the context of a user's home based upon the historical lemmings of the device.

Random indexing is an example of a geometric model for context realization. Geometric models may represent terms as vectors in multi-dimensional space, the dimensions of which are derived from the distribution of terms across defined contexts, which may include entire documents, regions within documents, or grammatical relations.

A property of vector-space models may be that the semantic information is extracted automatically, in an unsupervised fashion from unstructured data. The models may require little or no preprocessing of data, and they may involve little or no human interaction. A term “vector-based semantic analysis” may be used to denote the practice of using statistical regularities in the data (for example, co-occurrence information) to automatically construct the vectors and the vector space. As an example, no prior knowledge of the data is assumed, making the models easy to apply to data with different topical and structural properties.

Consequently, vector-space models are inherently adaptive when applied to new domains, since the dynamics of the semantic space will reflect the semantics of the training data. This means that different domains will produce different semantic spaces, with different semantic relations between different words. For example, if we train the model on a zoological database, “mouse” will most certainly be correlated with other words referring to, for example, small, furry animals or rodents, while if we train the model on documents with computer-related subjects, “mouse” will presumably be correlated with other words referring to, for example, computer hardware. As a matter for empirical validation, this feature may also make the models easily applicable to different languages.

A random-index (RI) technique for a contextual intelligence system for context realization can be described as a two-step operation as follows. First, each context (e.g., each word) in the data is assigned a unique and randomly generated representation called an index vector. These index vectors are sparse, high-dimensional, and ternary, which means that their dimensionality (d) is on the order of hundreds or thousands or more, and that they consist of e.g., a small number of randomly distributed +1s and −1s or other small numbers, with the rest of the elements of the vectors set to zero. Then, context vectors are produced by scanning through the text, and each time a word occurs in a context (e.g., in a document or within a sliding context window), that context's d-dimensional index vector is added to the context vector for the word in question. Words are thus represented by d-dimensional context vectors that are effectively the sum of the words' contexts.

For illustration, consider the sentence “A friend in need is a friend indeed.” Let the dimension of the index vector be 10, and the context be defined as one preceding and one succeeding word. Let “friend” be assigned a random index vector of [0 0 0 1 0 0 0 0-1 0], and ‘need’ be assigned a random index vector of [0 1 0 0-1 0 0 0 0 0]. Then to compute the context vector of “in,” RI sums up the index vectors of its context. Since the context is defined as one preceding and one succeeding word, the context vector of “in” is the sum of the index vectors of “friend” and “need,” and is equal to [0 1 0 1-1 0 0 0-1 0].

Contextual intelligence systems can learn a user's behaviors and habits and use a technique, such as a random index technique, to predict a user's next potential action or actions through the behavioral learnings. Generally, the learnings are based on a user's historical actions and behaviors. However, in conventional contextual intelligence systems, it may not be possible to take into account any information outside of what a user has generated historically through prior behaviors. Contextual intelligence based upon historical learnings and behaviors may be limited in instances where a context occurs rarely such that there is little historical knowledge on which to predict a user's potential next action.

One example of contextual intelligence may include a context which includes the words: morning, weekend, rainy, home. Such a context may have historical behavior information that indicates on rainy, weekend mornings when the user is at home, the user generally reads a particular digital publication. In such an embodiment, the device (e.g., apparatus 50), upon recognizing the context (e.g., through context engine 80) may download or access the particular digital publication before receiving a request from the user such that upon receiving a request from the user, the digital publication has been downloaded and is ready for viewing by a user.

Example embodiments of the invention may provide a mechanism to implement a contextual intelligence system based upon a random index technique where a user can combine personal and social behavior learnings or give different weight to personal and social learnings. Social learnings may be generated from information received from other users or the devices of other users such as through crowd-sourcing and stored in a memory, such as memory 76 or within the context engine 80. Such learnings can be incorporated into a context database (e.g., a context matrix) that is used by a random index technique to predict a user's next potential action using, for example, the context engine 80. The contextual intelligence system of example embodiments may be used to adapt device user interface and device behavior so that it best suits a user's future needs and behaviors.

In an example embodiment, a user's device may collect a user's historical behaviors in a context database, such as in a matrix to be used in a random index technique. The matrix may contain all relations of words that are important for the user of that particular device, and a context associated with each word or with groups of words. On occasion, a given context may not have sufficient historical behavior data to accurately be identified by the device, such as where the matrix does not provide quality information regarding what actions or behaviors are likely to occur next. The contextual intelligence system of example embodiments may request additional information from the user to help identify the context. The additional information provided by a user may then be used to improve future identification of the context and the prediction of behaviors or actions that are likely to occur in such a context.

Context quality may be rated based upon a confidence index. For example, a context that is regularly encountered by a device may be quickly and reliably recognized by the device. A context regularly encountered by a device may include contexts that are part of a user's daily routine, such as at home in the evening, commuting to work on a bus, exercising at a particular gym, etc. Such contexts may include further detail such as weather, season, or other details that a device may use to assist in the prediction of behaviors and actions of a user. The confidence of regularly encountered contexts may be very high, whereas confidence of rarely encountered contexts may be very low. Such confidence may be represented by a percentage such that a context encountered daily may have a near 100% confidence level whereas a context encountered for the first time may have a very low confidence of near 0% until behaviors are learned for the new context and the context is identifiable by a particular set of words. A context that has been encountered several previous times, but not on a regular schedule, may have a confidence of 30% which may increase with regular encounters and behaviors learned in relation to said context.

In an example embodiment of a context intelligence system that may request user input to help generate quality information for a context, the user input may be requested based upon a threshold confidence of the context. For example, if a context has a confidence level of 30% or less, user input may be requested (e.g., by the context engine 80) in order to increase the confidence level and better recognize the context when encountered in the future.

User input for a context intelligence system may be in the form of a word that describes the context or is otherwise related to the context. A user may enter a word (e.g., via user interface 72) and the device may add that word to a database (e.g., in memory device 76 or context engine 80) for use in recognizing the context in the future. The context intelligence may be further enhanced by the device causing a search to be performed relative to the word entered by the user. For example, a search may be performed using the word or words entered by a user. The search may be conducted over a network, for example using the internet via communication interface 74, to determine related words for enhancement of the context intelligence system. The search parameters for the search may include the word or words entered by the user, but may also include words pertaining to the context that are provided by the device without user input (e.g., words generated through detected properties of the environment of the device or via input received at a sensor). The search may be performed through an internet service, such as Wordnet. The search may use synonymy between words to find related words and may use word strings to find words that relate to the word string or concept.

As noted above, words that may be included as search parameters may not be user-entered, but may be words generated by the device (e.g., through context engine 80) in response to an environment or sensor. For example, if the device is moving at a high rate of speed (e.g., 50 miles per hour as determined by global positioning or cellular tower triangulation), the device may interpret the movement as in a vehicle and use words associated with vehicular travel as search parameters for the context. Similarly, if a device determines that it is in bright light through a photoelectric sensor, the device may presume the user is outside in sunlight and associate words with such a condition to be used as search parameters. Many other conditions or environmental factors may be detected or sensed by a device and interpreted by the context engine 80 as words related to a context.

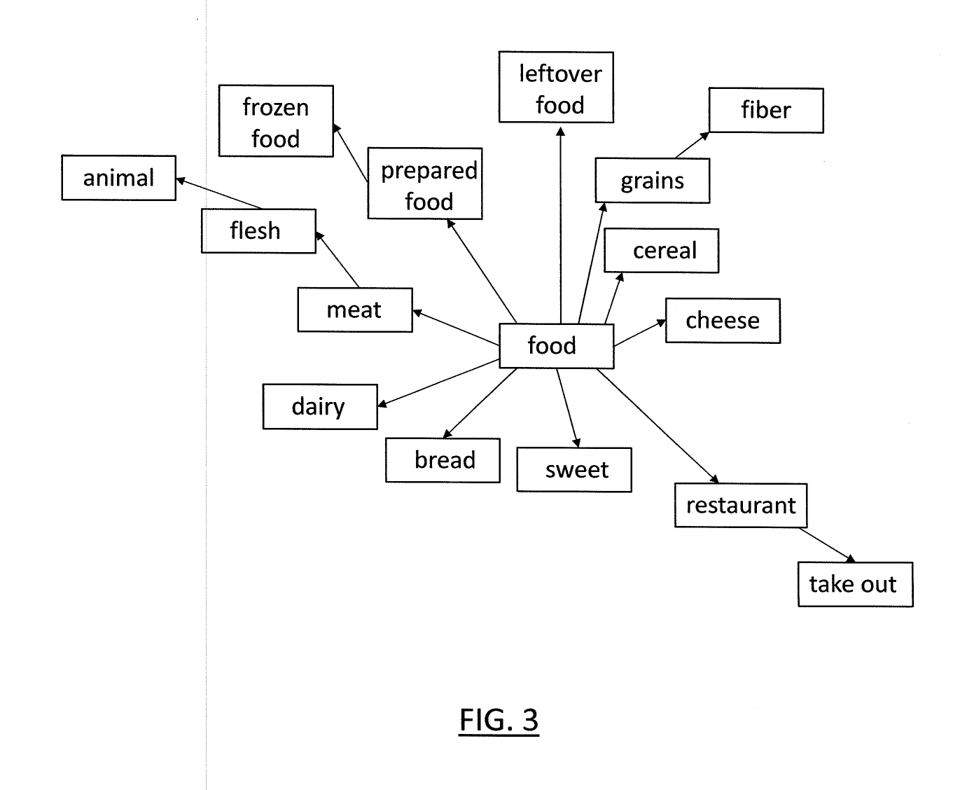

FIG. 3 illustrates a graphical representation of an example search that may be conducted via a network, such as an internet search via Wordnet. The illustrated embodiment depicts the central concept of “food” and words related thereto. The graph's center point of “food” may represent the word or concept that is seen as most central in relation to words that were provided as the search parameters. This central word or concept may be afforded a higher weight than other related words that are further away from the central word as detailed further below. The graph illustrated in FIG. 3 may be the graph resulting from a search including a user entered search parameter of “cuisine” and potentially other user entered search parameters or other device-provided search parameters which may include a time of day, such as around “lunch time.” The term “food” may be added to the context database together with words that are directly related to the term “food,” such as cheese, bread, meat, etc. The central term of “food” may be afforded a higher weight than other added terms when the words are added to the context intelligence database.

The weight of a word may influence how that word contributes to the determination of a context. For example, a word that is of a greater weight may supersede or provide greater influence in the determination of a context compared to a word of a lower weight. In an example embodiment in which the terms of FIG. 3 are added to a context database, the term “food” may be given a greater weight than the word “restaurant.” When the same or similar context is subsequently encountered, a device may recognize that it is lunch time and the user's behavior is likely to pursue food. The term “restaurant,” while relevant, may not influence the context as significantly as “food” as the term “restaurant” was afforded a lower weight. In such an embodiment, the device may recognize that the user's behavior is likely to pursue food for lunch, but not necessarily food from a restaurant.

In another example embodiment of a context intelligence system according to the present invention, a device may use words that represent a particular context. Those words may include: “eat,” “sweet,” and “solid.” The user may be asked to provide input to help the context intelligence system to better identify the context. The user may add the word “sugar” as the user input. The context intelligence system may then provide for a search to be conducted over a network, via communications interface 74, to ascertain additional words and descriptors representative of the context. The search may result in an XML (extensible mark-up language) schema where the search parameter(s) is/are present. The search may construct a graph based upon the received XML schemas (e.g., as shown in FIG. 3). The contextual intelligence system may then identify words and assign the highest weight to the words that are closest to the central concept of the graph. The weight afforded words may decrease as the words become more distant from the central word or concept. The contextual intelligence system may then add the selected words to the context database as additional words that describe the context which resulted in the search. Upon subsequent encounters with the same or similar context, the contextual intelligence system may have a broader knowledge base on which to base a context prediction and may not require the user input to facilitate context determination. As outlined above, this may be predicated on the confidence level that the context determination is sufficient to predict the actions and behaviors of a user with a level of accuracy.

Context intelligence systems according to example embodiments of the invention may add numerous words to a context database such that a context can be more reliably and repeatably obtained in future encounters. The greater the number of words, and the weights afforded the words, may provide a more accurate and broader description of a context such that the context becomes more meaningful and useful to a user, and the device is able to better predict the behaviors and actions of a user based upon the random index technique accessing a broader and enhanced context database.

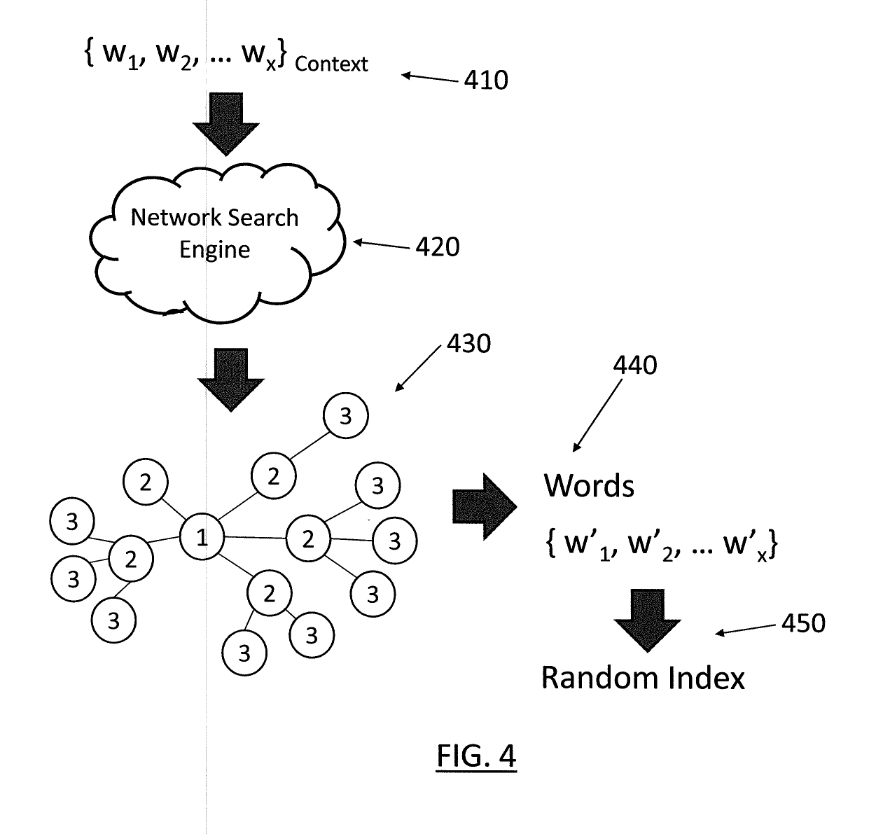

FIG. 4 is a flow diagram of a method of enhancing contextual intelligence according to an example embodiment of the present invention. A word, or multiple words, are determined to be relevant to the context at 410. The word or multiple words are used as search parameters in a search performed by the network search engine, which may be a search service such as Wordnet at 420. The search produces search results at 430. The search results may include a most relevant word, indicated by the number “1,” related words indicated by the number “2,” and more distantly related words indicated by the number “3.” The most relevant word (1) and the related words (2) may be sent to a user device as relevant to the context while the least relevant words (3) may be ignored. The words may include a weight that is determined by the relevance to the search terms and deemed relevant to the context which was represented by the search terms. The more relevant a search result word is, the higher the weight it is afforded. The search result words are received by a user device at 440 and subsequently used for random index determination of contexts going forward at 450.

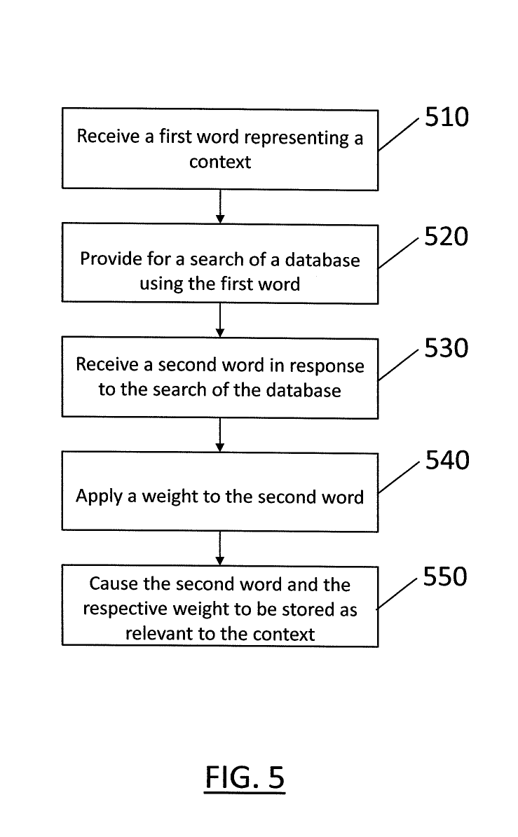

FIG. 5 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal or other device and executed by a processor in the user terminal or other device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 5, may include receiving a first word representing a context at 510. A search may be performed of a database using the first word at 520. The search may produce search results that include a second word in response to the search of the database at 340. A weight may be applied to the second word at 540. The second word and its respective weight may be stored as relevant to the context at 550.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein. In some embodiments, the database may include a remote database, such as a database or search engine accessible via a network such as the interne. The method may also include generating a third word in response to a sensor receiving an input, where the search of the database may include using the first word and the third word. Methods may optionally include generating a third word in response to a detected property of an environment, such as a time of day, weather, temperature, location, etc. and the search of the database may include using the first word and the third word. The weight of the second word may represent the relevance of the second word to the context. Methods may include requesting user input relative to the context, where the first word is received in response to the request for user input. Requesting user input may be performed in response to a context confidence level being below a pre-defined threshold indicating that the context is not reliably established.

In an example embodiment, an apparatus for performing the method of FIG. 5 above may comprise a processor (e.g., the processor 70) configured to perform some or each of the operations (510-550) described above. The processor may, for example, be configured to perform the operations (510-550) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 510-550 may comprise, for example, the context engine 80. Additionally or alternatively, at least by virtue of the fact that the processor 70 may be configured to control or even be embodied as the context engine 80, the processor 70, and/or a device or circuitry for executing instructions or executing an algorithm for processing information as described above may also form example means for performing operations 510-550.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1.-28. (canceled)

29. A method comprising:
receiving a first word representing a context at a processor;
providing for a search of a database using the first word;
receiving a second word in response to the search of the database;
applying a weight to the second word; and
causing the second word and the respective weight to be stored as relevant to the context.

30. The method of claim 28, wherein the database comprises a remote database.

31. The method of claim 28, further comprising generating a third word in response to a sensor receiving an input, wherein providing for a search of a database comprises using the first word and the third word.

32. The method of claim 28, further comprising generating a third word in response to a detected property of an environment, wherein providing for a search of a database comprises using the first word and the third word.

33. The method of claim 28, wherein the weight of the second word represents the relevance of the second word to the context.

34. The method of claim 28, further comprising requesting user input relative to the context, where the first word is received in response to the request for user input.

35. The method of claim 34, wherein requesting user input relative to the context is performed in response to a context confidence level being below a pre-defined threshold.

36. An apparatus comprising at least one processor and at least one memory including computer program code, the at least one memory and the computer program code configured to, with the at least one processor, cause the apparatus at least to:
receive a first word representing a context;
provide for a search of a database using the first word;
receive a second word in response to the search of the database;
apply a weight to the second word; and
cause the second word and the respective weight to be stored as relevant to the context.

37. The apparatus of claim 36, wherein the database comprises a remote database.

38. The apparatus of claim 36, wherein the apparatus is further caused to generate a third word in response to a sensor receiving an input, wherein providing for a search of a database comprises using the first word and the third word.

39. The apparatus of claim 36, wherein the apparatus is further caused to generate a third word in response to a detected property of an environment, wherein providing for a search of a database comprises using the first word and the third word.

40. The apparatus of claim 36, wherein the weight of the second word represents the relevance of the second word to the context.

41. The method of claim 36, wherein the apparatus is further caused to request user input relative to the context, where the first word is received in response to the request for user input.

42. The apparatus of claim 41, wherein requesting user input relative to the context is performed in response to a context confidence level being below a pre-defined threshold.

43. A computer program product comprising at least one non-transitory computer-readable storage medium having computer-executable program code instructions stored therein, the computer-executable program code instructions comprising:
program code instructions for receiving a first word representing a context;
program code instructions for providing for a search of a database using the first word;
program code instructions for receiving a second word in response to the search of the database;
program code instructions for applying a weight to the second word; and
program code instructions for causing the second word and the respective weight to be stored as relevant to the context.

44. The computer program product of claim 43, wherein the database comprises a remote database.

45. The computer program product of claim 43, further comprising program code instructions for generating a third word in response to a sensor receiving an input, wherein the program code instructions for providing for a search of a database comprises using the first word and the third word.

46. The computer program product of claim 43, further comprising program code instructions for generating a third word in response to a detected property of an environment, wherein the program code instructions for providing for a search of a database comprises using the first word and the third word.

47. The computer program product of claim 43, wherein the weight of the second word represents the relevance of the second word to the context.

48. The computer program product of claim 43, further comprising program code instructions for requesting user input relative to the context, where the first word is received in response to the request for user input.
